(19) United States
(12) Patent Application Publication
(10) Pub. No.: US 2004/0116159 A1
(43) Pub. Date: Jun. 17, 2004

(54) Hands-free device with a built-in audio pickup unit and loudspeaker unit

(76) Inventor: Te-Chung Cheng, Hsin-Chu City (TW)

Correspondence Address: DANIEL B. SCHEIN, PH.D.,ESQ., 1738 PAYRUS LANE, SAN JOSE, CA, 95126, US

(21) Appl. No.: 10/318,860

(22) Filed: Dec. 13, 2002

(51) Int. Cl. H04M 1/00

(52) U.S. Cl. 455/569.1; 455/550.1

(57) ABSTRACT

A hands-free device includes a housing, an audio pickup unit mounted in the housing and adapted to receive a sound output from a sound source and to convert the sound output into an audio signal, an amplifier unit mounted in the housing and coupled electrically to the audio pickup unit for amplifying the audio signal, and a loudspeaker unit mounted in the housing and coupled electrically to the amplifier unit for reproducing an amplified output of the amplifier unit.

### BACKGROUND OF THE INVENTION

1. Field of the Invention

The invention relates to a hands-free device, more particularly to a hands-free device with a built-in audio pickup unit and loudspeaker unit.

2. Description of the Related Art

As wireless technology continues to develop and improve, mobile phones have become more affordable, and have improved in terms of quality and functionality. This results in an ever increasing popularity of the mobile phones. In fact, the mobile phone has become an indispensable communication tool for our everyday lives. However, it is sometimes inconvenient for the user, for example, to use one hand to hold the mobile phone and the other hand to write notes, or even dangerous, for example, to use one hand to hold the mobile phone and the other hand to manipulate a steering wheel while driving. Therefore, various kinds of earphone units have been developed for mobile phones.

As shown in FIG. 1, the conventional earphone unit 11 comprises an earphone 113, a microphone 112 connected electrically to the earphone 113, and a plug 111 connected electrically to the microphone 112 and plugged into a socket 121 of a mobile phone 12. In use, the user fits the earphone 113 into one's ear. Since the microphone 112 is located near the user's mouth when the earphone 113 is fitted into the ear, the user can use the mobile phone 12 without having to hold the mobile phone 12.

Although the aforementioned conventional earphone unit 11 can provide users with much convenience and safety, it is found, based on current research, that the earphone unit 11 acts as an antenna and radiates electromagnetic waves. The earphone unit 11, when used, puts the user's brain at risk of exposure to electromagnetic wave radiation.

While it is known in the art to connect an external speaker to a mobile phone for hands-free call receiving purposes, since the sockets 121 of the mobile phones 12 vary among different models of the mobile phones 12, the external speaker cannot be provided with the plugs 111 that can be compatible for the many models of the mobile phones 12.

### SUMMARY OF THE INVENTION

Therefore, the object of the present invention is to provide a hands-free device that reproduces loudly the sound output from a mobile phone and that is not required to be connected physically to the mobile phone.

According to the present invention, a hands-free device comprises a housing, an audio pickup unit mounted in the housing and adapted to receive a sound output from a sound source and to convert the sound output into an audio signal, an amplifier unit mounted in the housing and coupled electrically to the audio pickup unit for amplifying the audio signal, and a loudspeaker unit mounted in the housing and coupled electrically to the amplifier unit for reproducing an amplified output of the amplifier unit.

### BRIEF DESCRIPTION OF THE DRAWINGS

Other features and advantages of the present invention will become apparent in the following detailed description of the preferred embodiments with reference to the accompanying drawings, of which:

FIG. 1 illustrates a conventional earphone unit plugged into a mobile phone;

FIG. 2 is a schematic circuit block diagram of the first preferred embodiment of a hands-free device according to the present invention;

FIG. 3 is a schematic circuit diagram of the first preferred embodiment;

FIG. 4 illustrates the first preferred embodiment in a state of use;

FIG. 5 is a perspective view of the first preferred embodiment; and

FIG. 6 is a schematic circuit diagram of the second preferred embodiment of a hands-free device according to the present invention.

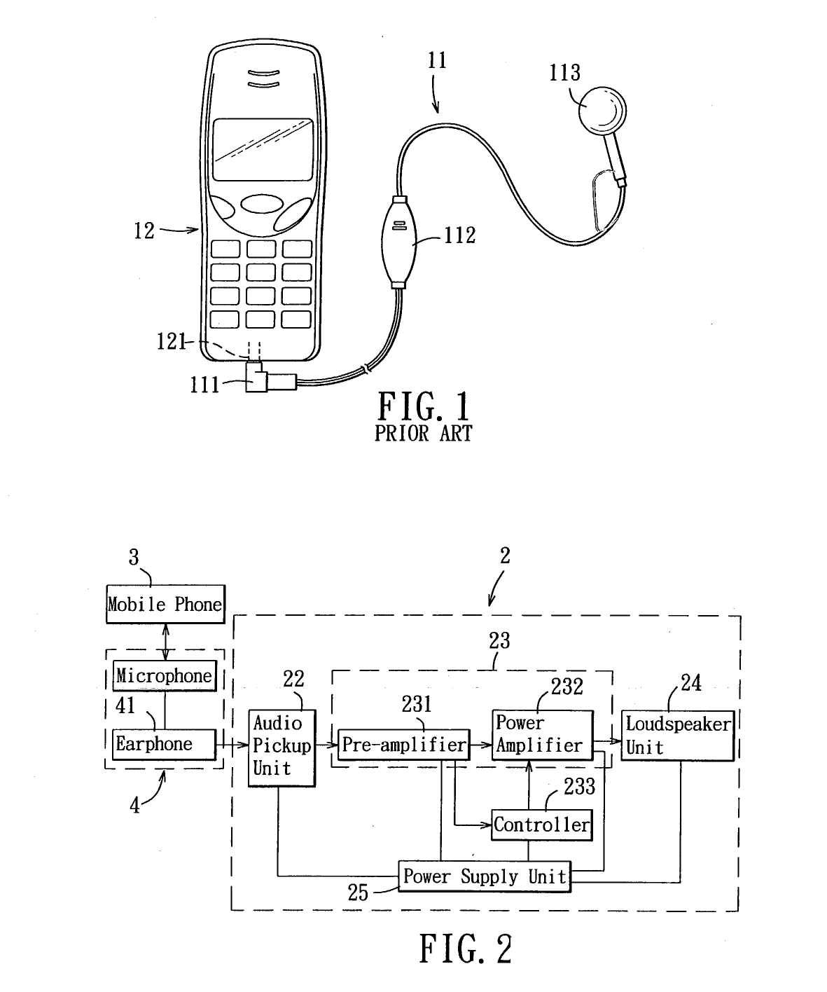

### DETAILED DESCRIPTION OF THE PREFERRED EMBODIMENTS

Before the present invention is described in greater detail, it should be noted that like elements are denoted by the same reference numerals throughout the disclosure.

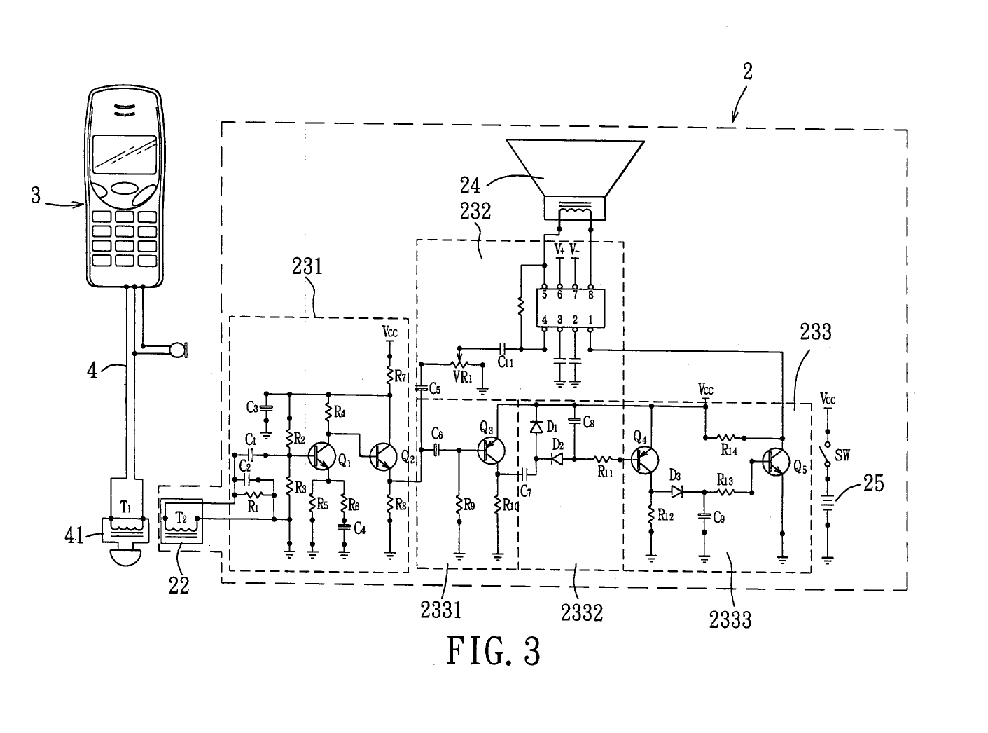

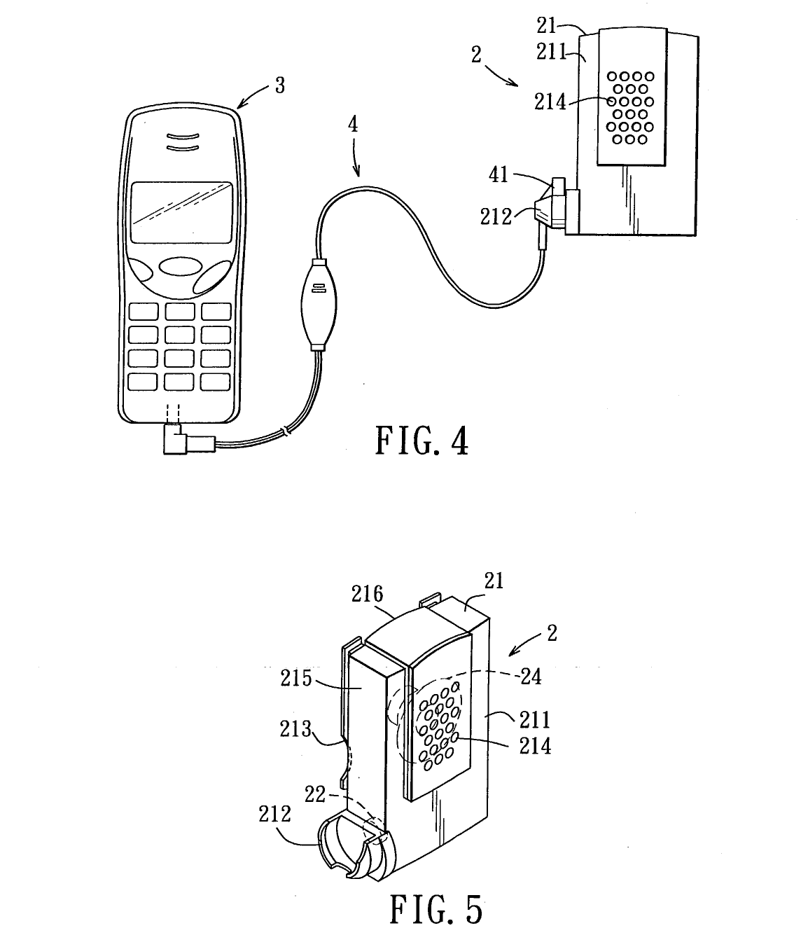

Referring to FIGS. 2 to 5, the first preferred embodiment of a hands-free device 2 according to the present invention is adapted for use with an earphone unit 4 that is connected to a mobile phone 3 and that serves as a sound source. The hands-free device 2 is shown to include a housing 21, an audio pickup unit 22, an amplifier unit 23, and a loudspeaker unit 24.

The housing 21 defines a receiving cavity to receive the audio pickup, amplifier and loudspeaker units 22, 23, 24. The housing 21 has a first side wall 215 formed with a positioning seat 212 that is adapted to position an earphone 41 of the earphone unit 4 on the first side wall 215 of the housing 21, a second side wall 211 disposed transverse to the first side wall 215 and formed with sound holes 214 therethrough, and a third side wall 216 opposite to the second side wall 211 and provided with a clip 213 for mounting purposes, such as for mounting on a belt, a waistband or other garment of the user. The housing 21 is generally rectangular in shape.

The audio pickup unit 22 is mounted in the housing 21, is adjacent to and directed toward the first side wall 215 of the housing 21, and is adapted to receive a sound output from the earphone 41 of the earphone unit 4 and to convert the sound output into an audio signal. Preferably, the audio pickup unit 22 is a directional moving coil microphone but a piezolelectric microphone or a condenser microphone could also be used. When the audio pickup unit 22 is a moving coil microphone, and the earphone 41 is positioned in the housing 21, a coil (T1) of the earphone 41 can couple electromagnetically with a coil (T2) of the audio pickup unit 22, thereby enabling the latter to convert the sound output of the earphone 41 into the requisite audio signal. The amplifier unit 23 is mounted in the housing 21, and includes a pre-amplifier 231 that has transistors Q1, Q2, capacitors C1, C2, C3, C4 and resistors R1, R2, R3, R4, R5, R6, R7, R8, and a power amplifier 232 that includes an eight-pin integrated circuit. The pre-amplifier 231 of the amplifier unit 23 is coupled electrically to the audio pickup unit 22 to amplify the audio signal therefrom. Pin 4 of the integrated circuit of the power amplifier 232 is coupled electrically to the pre-amplifier 231 through coupling capacitors C5, C11 and a variable resistor VR1 to provide further amplification of the amplified audio signal from the pre-amplifier 231 and to generate an amplified audio signal that is powerful enough to drive the loudspeaker unit 24. Pin 1 of the integrated circuit of the power amplifier 232 can be used to enable and disable the power amplifier 232 of the amplifier unit 23. That is, when the pin 1 is at a low logic level, the power amplifier 232 is enabled for normal operation. Conversely, when the pin 1 is at a high logic level, the power amplifier 232 is disabled. Preferably, the integrated circuit is a Motorola MC34119 low power audio amplifier.

The loudspeaker unit 24 is mounted in the housing 21, and faces the sound holes 214 in the second side wall 211 of the housing 21, and is coupled electrically to pins 5 and 8 of the integrated circuit of the power amplifier 232 of the amplifier unit 23. The loudspeaker unit 24 reproduces the amplified output of the power amplifier 232 of the amplifier unit 23. The audio pickup unit 22 and the loudspeaker unit 24 form a vertical clearance therebetween to minimize interference.

The hands-free device 2 further comprises a controller 233 that is mounted in the housing 21 to enable the operation of the power amplifier 232 only when the audio signal from the pre-amplifier 231 exceeds a preset threshold so as to conserve power. In this embodiment, the controller 233 includes an amplifying circuit 2331 coupled electrically to the pre-amplifier 231 of the amplifier unit 21 and having a capacitor C6, resistors R9, R10 and a transistor Q3, a rectifying circuit 2332 coupled electrically to the amplifying circuit 2331 and having capacitors C7, C8, diodes D1, D2, and a resistor R11, and a switching circuit 2333 coupled electrically to the rectifying circuit 2332 and to the power amplifier 232 of the amplifier unit 23 and having resistors R12, R13, R14, transistors Q4, Q5, a capacitor C9, and a diode D3. As such, when the amplified audio signal appears at the output of the pre-amplifier 231, the audio signal is fed simultaneously to the power amplifier 232 and the amplifying circuit 2331 of the controller 233. The amplifying circuit 2331 is processed by rectifying circuit 2332 of the controller 233 to produce a negative voltage. If the negative voltage exceeds the preset threshold, the transistors Q4, Q5 of the switching circuit 2333 of the controller 233 are turned on. In this embodiment, when the transistor Q5 of the switching circuit 2333 of the controller 233 is turned on, the pin 1 of the integrated circuit of the power amplifier 232, which is initially at a high logic level, is pulled to the low logic level, thereby enabling the operation of the power amplifier 232 of the amplifier unit 23.

As described above, to use the hands-free device 2, the earphone 41 of the earphone unit 4 is positioned on the positioning seat 212 on the first side wall 215 of the housing 21 such that the distance between the earphone 41 and the audio pickup unit 22 is preferably between 3 to 8-mm. The sound output from the earphone 41 of the earphone unit 4 is then received and converted into the desired audio signal by the audio pickup unit 22, amplified by the pre-amplifier 231, and supplied to the power amplifier 232 and the controller 233. When the amplified audio signal from the pre-amplifier 231 exceeds the preset threshold, the controller 233 pulls the pin 1 of the integrated circuit of the power amplifier 232 from the high logic level to the low logic level to enable the operation of the power amplifier 232. Finally, the loudspeaker unit 24 reproduces the amplified audio signal output from the power amplifier 232 of the amplifier unit 23.

The hands-free device of the present invention further comprises a power supplying unit 25 that interconnects the amplifier unit 23 to a power source (Vcc).

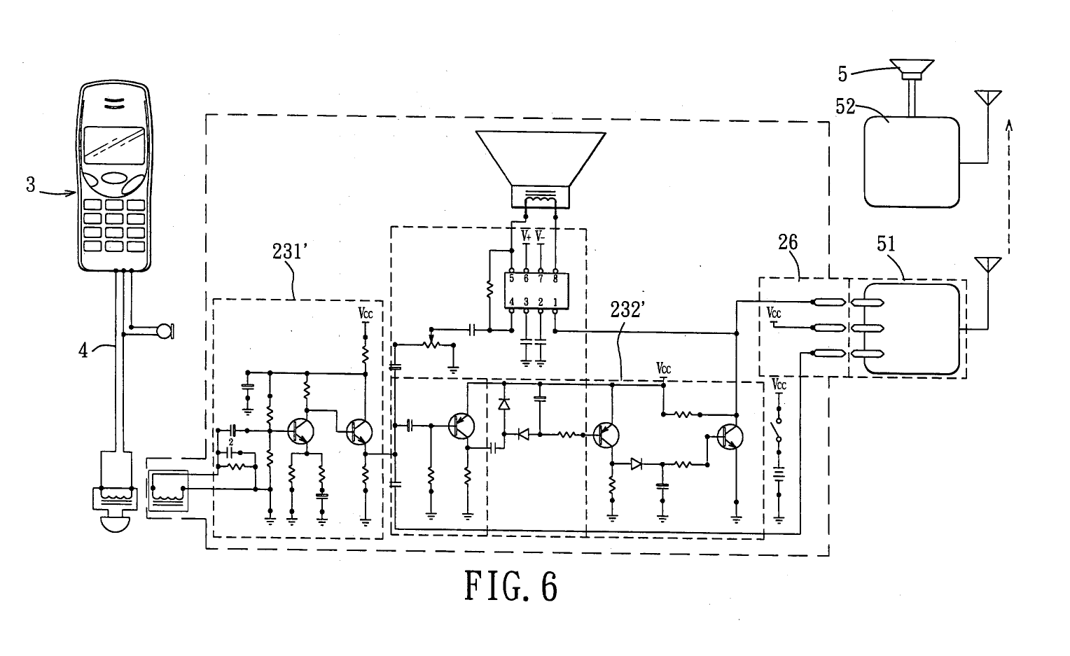

FIG. 6 is a schematic circuit diagram of a second preferred embodiment of a hands-free device according to the present invention. As illustrated, the hands-free device of this embodiment is generally similar to the previous embodiment except that, in this embodiment, the hands-free device further comprises a transmission port 26 coupled electrically to a junction of the pre-amplifier 231′ and the power amplifier 232′. The arrangement as such permits connection to an external speaker device with a higher power rating for louder reproduction of the sound output. Moreover, the transmission port 26 can be also connected to a wireless transmitter 51 to transmit the sound output of the earphone of the earphone unit 4 wirelessly to an external speaker device that comprises a wireless receiver unit 52 and a loudspeaker unit 5.

It has thus been shown that the hands-free device 2 of the present invention is provided with the loudspeaker unit 24, for reproduction of the sound output from the earphone 41 of the earphone unit 4. As such, it is no longer necessary for the user to wear the earphone 41, and the risk of exposure of the user's brain to electromagnetic radiation is eliminated. Moreover, since the hands-free device 2 receives the sound output from the earphone 41 of the earphone unit 4, the hands-free device 2 does not have to be physically connected to the mobile phone 3. The object of the present invention is thus met.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A hands-free device comprising:
a housing;
an audio pickup unit mounted in said housing and adapted to receive a sound output from a sound source and to convert the sound output into an audio signal;
an amplifier unit mounted in said housing and coupled electrically to said audio pickup unit for amplifying the audio signal; and
a loudspeaker unit mounted in said housing and coupled electrically to said amplifier unit for reproducing an amplified output of said amplifier unit.

2. The hands-free device as claimed in claim 1, wherein said audio pickup unit is one of a moving coil microphone, a piezoelectric microphone and a condenser microphone.

3. The hands-free device as claimed in claim 1, wherein said amplifier unit includes a pre-amplifier coupled electrically to said audio pickup unit, and a power amplifier coupled electrically to said pre-amplifier and said loudspeaker unit.

4. The hands-free device as claimed in claim 3, further comprising a controller mounted in said housing and coupled electrically to said amplifier unit, said controller enabling operation of said power amplifier only when the audio signal from said pre-amplifier exceeds a preset threshold.

5. The hands-free device as claimed in claim 3, further comprising a transmission port coupled electrically to a junction of said pre-amplifier and said power amplifier and adapted to be connected to an external speaker device.

6. The hand-free device as claimed in claim 1, wherein said housing is provided with a clip for mounting purposes.

7. A hands-free device adapted for use with an earphone that serves as a sound source, said hands-free device comprising:
a housing having a first side wall formed with a positioning seat that is adapted to position the earphone on said housing;
an audio pickup unit mounted in said housing adjacent to said first side wall, said audio pickup unit being adapted to receive a sound output from the earphone and to convert the sound output into an audio signal;
an amplifier unit mounted in said housing and coupled electrically to said audio pickup unit for amplifying the audio signal; and
a loudspeaker unit mounted in said housing and coupled electrically to said amplifier unit for reproducing an amplified output of said amplifier unit.

8. The hands-free device as claimed in claim 7, wherein said housing further has a second side wall disposed transverse to said first side wall and formed with sound holes therethrough, said loudspeaker unit facing said sound holes in said second side wall when mounted in said housing.

9. The hands-free device as claimed in claim 8, wherein said audio pickup unit and said loudspeaker unit form a vertical clearance therebetween.

10. The hands-free device as claimed in claim 8, wherein said audio pickup unit is a directional moving coil microphone directed toward said first side wall.

11. The hand-free device as claimed in claim 8, wherein said housing further has a third side wall opposite to said second side wall and provided with a clip for mounting purposes.

12. The hands-free device as claimed in claim 7, wherein said amplifier unit includes a pre-amplifier coupled electrically to said audio pickup unit, and a power amplifier coupled electrically to said pre-amplifier and said loudspeaker unit.

13. The hands-free device as claimed in claim 12, further comprising a controller mounted in said housing and coupled electrically to said amplifier unit, said controller enabling operation of said power amplifier only when the audio signal from said pre-amplifier exceeds a preset threshold.

14. The hands-free device as claimed in claim 12, further comprising a transmission port coupled electrically to a junction of said pre-amplifier and said power amplifier and adapted to be connected to an external speaker device.
